(19) United States
(12) Patent Application Publication
(10) Pub. No.: US 2025/0342628 A1
(43) Pub. Date: Nov. 6, 2025

(54) EDITING DIGITAL IMAGES USING EXECUTABLE CODE GENERATED BY LARGE LANGUAGE MODELS FROM NATURAL LANGUAGE INPUT

(71) Applicant: Adobe Inc., San Jose, CA (US)

(72) Inventors: Handong Zhao, San Jose, CA (US); Qiucheng Wu, Goleta, CA (US); Trung Bui, San Jose, CA (US); Seunghyun Yoon, Seoul (KR); Quan Tran, San Jose, CA (US); Jing Shi, Rochester, NY (US)

(21) Appl. No.: 18/654,904

(22) Filed: May 3, 2024

(51) Int. Cl. G06T 11/60; G06T 7/11

(52) U.S. Cl. CPC G06T 11/60; G06T 7/11

(57) ABSTRACT

The present disclosure relates to systems, methods, and non-transitory computer-readable media that perform text-to-image editing using executable code generated from natural language text input. For instance, in one or more embodiments, the disclosed systems receive, from a client device, a digital image and natural language text input providing instructions for modifying the digital image. The disclosed systems also generate, using a large language model, executable action code for modifying the digital image in accordance with the instructions of the natural language text input, the executable action code being compatible with an editing application. The disclosed systems further modify the digital image by executing the executable action code via the editing application and provide the modified digital image for display via a graphical user interface of the client device.

### BACKGROUND

Recent years have seen significant advancement in hardware and software platforms for editing digital images. Indeed, as the use of digital images has become increasingly ubiquitous, systems have developed to facilitate the manipulation of the content within such digital images. To illustrate, many systems offer various tools that enable various changes to the content of digital images. Some systems use a model implementing artificial intelligence to generate a modified version of a digital image having edited content.

### SUMMARY

One or more embodiments described herein provide benefits and/or solve one or more problems in the art with systems, methods, and non-transitory computer-readable media that implement a flexible and interactive text-based framework that modifies digital images using executable code generated from natural language input. To illustrate, in one or more embodiments, a system uses a large language model to generate executable code that modifies a digital image based on instructions provided by natural language input. In some cases, the system leverages the in-context learning capability of the large language model by using code examples to format the model outputs for compatibility with a target editing application. The system executes the generated code via the editing application to generate a modified image. In some cases, the system performs independent actions in editing a digital image, enabling user interactions to intervene at any stage of the editing process to adjust one or more of those actions. In this manner, the system provides a flexible, interactive editing experience that uses editing tools of an editing application to modify a digital image based on a natural language description of the modification.

Additional features and advantages of one or more embodiments of the present disclosure are outlined in the description which follows, and in part will be obvious from the description, or are learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a text-to-image editing system operates in accordance with one or more embodiments;

FIG. 2 illustrates an overview diagram of the text-to-image editing system modifying a digital image based on natural language text input in accordance with one or more embodiments;

FIGS. 3A-3C illustrate the text-to-image editing system generating and executing executable action code to modify a digital image based on natural language text input in accordance with one or more embodiments;

FIG. 4 illustrates using in-context examples to facilitate the generation of output from a large language model in accordance with one or more embodiments;

FIGS. 5A-5E illustrate the text-to-image editing system modifying a digital image based on user input received via a graphical user interface of a client device in accordance with one or more embodiments;

FIG. 6 illustrates a table providing editing features of the text-to-image editing system in accordance with one or more embodiments;

FIG. 7 illustrates an example schematic diagram of a text-to-image editing system in accordance with one or more embodiments;

FIG. 8 illustrates a flowchart for a series of acts for performing text-to-image editing using executable action code generated from natural language text input in accordance with one or more embodiments; and

FIG. 9 illustrates a block diagram of an exemplary computing device in accordance with one or more embodiments.

### DETAILED DESCRIPTION

One or more embodiments described herein include a text-to-image editing system that modifies digital images using executable code generated from natural language text input. For instance, in some embodiments, the text-to-image editing system receives an editing request for modifying a digital image in the form of natural language text and infers key elements indicated therein, such as an editing object and low-level editing actions. In some cases, the text-to-image editing system determines a specific region within the digital image that is related to the editing object and retrieves examples of executable code that are related to the low-level editing actions. In some embodiments, based on the determined region and code examples, the text-to-image editing system leverages the in-context learning of a large language model to synthesize an action sequence for modifying the digital image in the form of executable code formatted for compatibility with a targeted image editing application. The text-to-image editing system executes the code via the image editing application to produce the editing result. In some implementations, the text-to-image editing system further adjusts the action sequence based on user input, incorporating interactivity to the editing process.

To illustrate, in one or more embodiments, the text-to-image editing system receives, from a client device, a digital image and natural language text input providing instructions for modifying the digital image. The text-to-image editing system further generates, using a large language model, executable action code for modifying the digital image in accordance with the instructions of the natural language text input, the executable action code being compatible with an editing application. Executing the executable action code via the editing application, the text-to-image editing system modifies the digital image. The text-to-image editing system provides the modified digital image for display via a graphical user interface of the client device.

As just indicated, in one or more embodiments, the text-to-image editing system generates executable action code that is compatible with an editing application from natural language text input. In certain embodiments, the text-to-image editing system uses one or more neural networks to generate the executable action code from the natural language text input.

For example, in one or more embodiments, the text-to-image editing system uses a large language model to determine, from the natural language text input, an object targeted for modification and one or more editing actions for modifying the object. In some embodiments, the text-to-image editing system also uses a segmentation model to determine an editing region of the digital image that corresponds to the object. Further, in some cases, the text-to-image editing system uses the large language model to generate executable action code to cause the editing application to modify the digital image by implementing the editing action(s) to modify the editing region. The text-to-image editing system executes the executable action code via the editing application to generate the editing results.

As further mentioned, in some embodiments, the text-to-image editing system uses the in-context learning capability of the large language model when generating outputs. To illustrate, in some cases, the text-to-image editing system provides one or more in-context examples to the large language model to promote the generation of natural language text output that identifies objects and/or editing actions from the natural language text input. Further, in some instances, the text-to-image editing system provides one or more executable code examples to the large language model to promote the generation of executable action code that is compatible with the target editing application. Indeed, in some implementations, the text-to-image editing system uses the in-context examples (including the executable code examples) to enable the large language model to generate outputs in a particular format.

Additionally, as discussed above, in one or more embodiments, the text-to-image editing system enables user input to adjust the editing process. In particular, in some cases, the text-to-image editing system implements an action sequence that includes distinct actions, such as an action sequence that includes selecting an editing region within a digital image and performing one or more modifications to the editing region. In some instances, the text-to-image editing system receives user input for changing one of the actions in the action sequence, such as user input for modifying the editing region. Thus, in certain implementations, the text-to-image editing system changes the action sequence in response to the user input to provide an editing result that is fine tuned to the user intent indicated by the user input.

The text-to-image editing system provides advantages over conventional systems. Indeed, conventional image editing systems suffer from several technological shortcomings that result in inefficient and inflexible operation. To illustrate, many conventional systems are inefficient in that they require a significant number of user interactions to modify a digital image. In particular, many conventional systems offer a robust set of powerful editing tools that enable various changes to a digital image. Often, more tools are added over time to provide additional editing options. By offering many different tools, however, these conventional systems often complicate the editing process. For instance, such conventional systems often require a significant number of user interactions with a graphical user interface to navigate windows, menus, and sub-menus to locate a desired tool. Some of these systems require additional user interactions to adjust the settings of a selected tool and to apply and fine-tune the application of the tool.

Additionally, conventional image editing systems often fail to operate flexibly. For instance, some conventional systems employ diffusion neural networks (e.g., conditioned via a contrastive language image pre-training (CLIP) encoder) for modifying digital images to ease the burden of navigating through complicated graphical user interfaces. Such systems often enable arbitrary text descriptions to guide the diffusion process. Diffusion models, however, typically lack controllability due to their inherent limitation in preserving existing content that is not intended to change or in accommodating fine-grained instructions. Indeed, many systems employing diffusion neural networks are limited to global edits. Further, systems employing diffusion models typically implement an end-to-end editing process that prevents user input for adjusting the edits made. If the editing result is unsatisfactory, these systems typically require the editing process to be re-initiated.

One or more embodiments of the text-to-image editing system operate with improved efficiency when compared to conventional systems. For example, by modifying a digital image based on natural language text input providing editing instructions, the text-to-image editing system reduces the number of user interactions that are required to obtain an editing result. Indeed, rather than require user interactions for navigating a graphical user interface and configuring and applying a selected editing tool, the text-to-image editing system performs various behind—the scenes operations-such as generating executable action code—that result in the automated modification of a digital image.

Additionally, one or more embodiments of the text-to-image editing system operate with improved flexibility when compared to conventional systems. To illustrate, by generating executable action code that is compatible with an editing application, the text-to-image editing system leverages the editing tools and features that are already available from the editing application. By implementing an action sequence having distinct actions, the text-to-image editing system allows for user interactions to intercede to adjust one or more of the actions, enabling more fine-tuned image editing results. Further, by leveraging the editing tools and features available under an editing application, embodiments of the text-to-image editing system allows for a more robust set of edits to be made from a single natural language text input when compared to many conventional systems, such as local edits, multiple edits on the same object, or multiple edits on different objects.

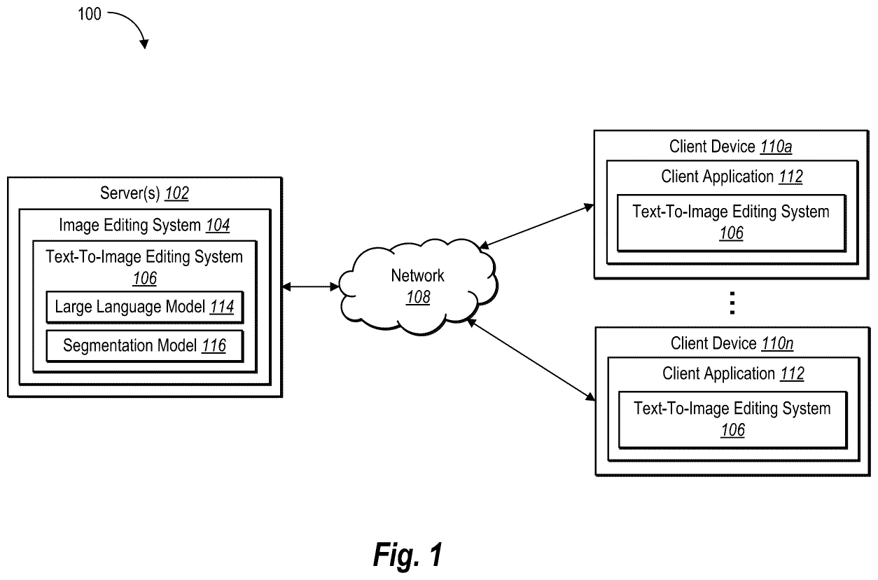

Additional detail regarding the text-to-image editing system will now be provided with reference to the figures. For example, FIG. 1 illustrates a schematic diagram of an exemplary system 100 in which a text-to-image editing system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the text-to-image editing system 106 via the network 108). Similarly, although FIG. 1 illustrates a particular arrangement of the server(s) 102, the network 108, and the client devices 110a-110n, various additional arrangements are possible.

The server(s) 102, the network 108, and the client devices 110a-110n are communicatively coupled with each other either directly or indirectly (e.g., through the network 108 discussed in greater detail below in relation to FIG. 9). Moreover, the server(s) 102 and the client devices 110a-110n include one or more of a variety of computing devices (including one or more computing devices as discussed in greater detail with relation to FIG. 9).

As mentioned above, the system 100 includes the server(s) 102. In one or more embodiments, the server(s) 102 generates, stores, receives, and/or transmits data, including digital images and/or modified digital images. In one or more embodiments, the server(s) 102 comprises a data server. In some implementations, the server(s) 102 comprises a communication server or a web-hosting server.

In one or more embodiments, the image editing system 104 provides functionality by which a client device (e.g., a user of one of the client devices 110a-110n) generates, edits, manages, and/or stores digital images. For example, in some instances, a client device sends a digital image to the image editing system 104 hosted on the server(s) 102 via the network 108. The image editing system 104 then provides many options that are usable by the client device to edit the digital image, store the digital image, and subsequently search for, access, and view the digital image. For instance, in some cases, the image editing system 104 provides one or more options that are usable by the client device to modify a digital image via submission of natural language text input.

In one or more embodiments, the client devices 110a-110n include computing devices that are capable of accessing, modifying, and/or storing digital images, including modified digital images. For example, in some embodiments, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that are capable of accessing, modifying, and/or storing digital images, including modified digital images. For example, in some embodiments, the client application 112 includes a software application installed on the client devices 110a-110n. Additionally, or alternatively, the client application 112 includes a web browser or other application that accesses a software application hosted on the server(s) 102 (and supported by the image editing system 104).

To provide an example implementation, in some embodiments, the text-to-image editing system 106 on the server(s) 102 supports the text-to-image editing system 106 on the client device 110n. For instance, in some cases, the text-to-image editing system 106 on the server(s) 102 generates or learns parameters for the large language model 114 and/or the segmentation model 116. The text-to-image editing system 106 then, via the server(s) 102, provides the large language model 114 and/or the segmentation model 116 to the client device 110n. In other words, the client device 110n obtains (e.g., downloads) the large language model 114 and/or the segmentation model 116 (e.g., with any learned parameters) from the server(s) 102. Once downloaded, the text-to-image editing system 106 on the client device 110n utilizes the large language model 114 and/or the segmentation model 116 to modify digital images independent from the server(s) 102.

In alternative implementations, the text-to-image editing system 106 includes a web hosting application that allows the client device 110n to interact with content and services hosted on the server(s) 102. To illustrate, in one or more implementations, the client device 110n accesses a software application supported by the server(s) 102. The client device 110n provides input to the server(s) 102, such as a digital image and natural language text input for modifying the digital image. In response, the text-to-image editing system 106 on the server(s) 102 modifies the digital image based on the natural language text input. The server(s) 102 then provides the modified digital image to the client device 110n for display.

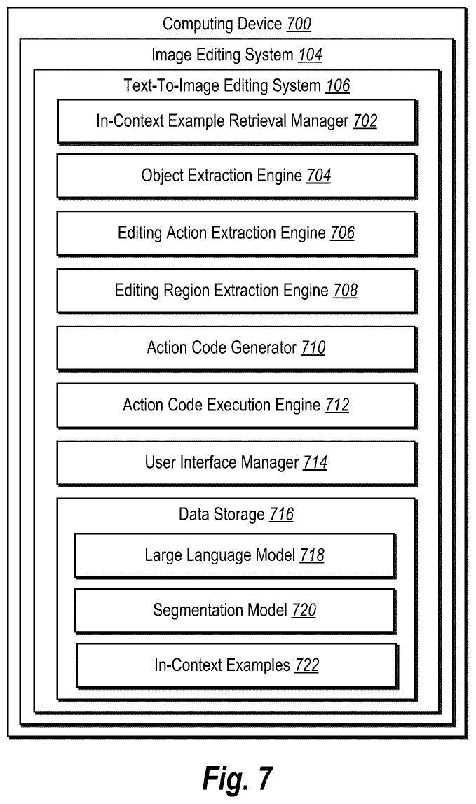

Indeed, the text-to-image editing system 106 is able to be implemented in whole, or in part, by the individual elements of the system 100. Indeed, although FIG. 1 illustrates the text-to-image editing system 106 implemented with regard to the server(s) 102, different components of the text-to-image editing system 106 are able to be implemented by a variety of devices within the system 100. For example, one or more (or all) components of the text-to-image editing system 106 are implemented by a different computing device (e.g., one of the client devices 110a-110n) or a separate server from the server(s) 102 hosting the image editing system 104. Indeed, as shown in FIG. 1, the client devices 110a-110n include the text-to-image editing system 106. Example components of the text-to-image editing system 106 will be described below with regard to FIG. 7.

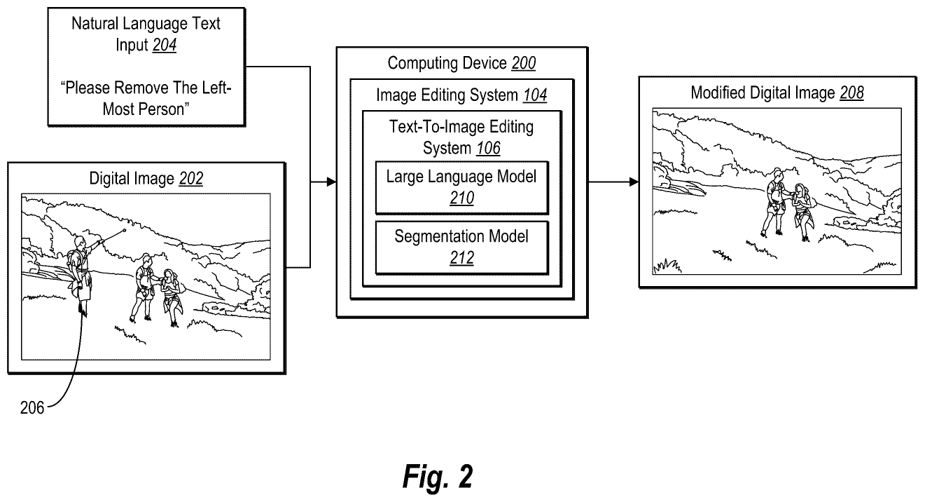

As mentioned, in one or more embodiments, the text-to-image editing system 106 modifies a digital image based on natural language text input. In particular, the text-to-image editing system 106 modifies the digital image based on instructions provided by the natural language text input. FIG. 2 illustrates the text-to-image editing system 106 modifying a digital image based on natural language text input in accordance with one or more embodiments.

As shown in FIG. 2, the text-to-image editing system 106 (operating on a computing device 200) receives a digital image 202 to be modified. As illustrated, the digital image 202 portrays various objects. In one or more embodiments, an object includes a distinct portion or segment of a digital image. In particular, in some embodiments, an object includes a portion or segment of a digital image that is distinguishable from other portions of the digital image. Indeed, in some cases, an object includes a distinct visual component portrayed within a digital image. Some examples of an object include, but are not limited to, a person, a car or other vehicle, a mountain, a building, a road, a sky, an animal, an article of clothing or accessory, or a distinct component of an article of clothing or accessory (e.g., a design or other component that is distinguishable from other portions of the article of clothing or accessory). In some instances, an object includes a higher-level segment of a digital image, such as the background or foreground of the digital image.

As further shown in FIG. 2, the text-to-image editing system 106 also receives natural language text input 204 for modifying the digital image. In one or more embodiments, natural language text input includes a text input in the form of natural language. In particular, in some embodiments, natural language text input includes a free-form text input composed of natural language text. In some instances, natural language text input includes (e.g., describes) an editing request or otherwise provides instructions for modifying a digital image. For instance, in some cases, natural language text input indicates a portion of a digital image to be modified and how that portion is to be modified. Indeed, in some implementations, natural language text input indicates that the digital image is to be modified as a whole (e.g., via one or more global edits) or one or more distinct portions (e.g., objects) of the digital image are to be modified (e.g., via one or more local edits).

As indicated by FIG. 2, the natural language text input 204 indicates that an object 206 (i.e., “the left-most person”) portrayed within the digital image 202 is to be modified. As further indicated, the natural language text input 204 indicates that the object 206 is to be modified by removing the object 206 from the digital image 202.

As further shown in FIG. 2, the text-to-image editing system 106 generates a modified digital image 208. In particular, the text-to-image editing system 106 modifies the digital image 202 in accordance with the natural language text input 204. Indeed, as illustrated, the text-to-image editing system 106 generates the modified digital image 208 by removing the object 206 from the digital image 202.

As illustrated, the text-to-image editing system 106 uses a large language model 210 and a segmentation model 212 to generate the large language model 210. In one or more embodiments, the large language model 210 and/or the segmentation model 212 include a neural network or other machine learning model.

In one or more embodiments, a neural network includes a type of machine learning model, which are tunable (e.g., trainable) based on inputs to approximate unknown functions used for generating the corresponding outputs. In particular, in some embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

In one or more embodiments, a large language model includes a computer-implemented machine learning model trained to comprehend and generate human language text. In particular, in some embodiments, a large language model includes a neural network (e.g., a deep neural network) with many parameters trained on large quantities of data (e.g., unlabeled text) using a particular learning technique (e.g., self-supervised learning). For example, in some cases, a large language model includes parameters trained to generate natural language text output from natural language text input. For instance, in certain instances, the text-to-image editing system 106 uses a large language model to generate natural language text output that indicates an object targeted by natural language text input for modification. Further, in some cases, the text-to-image editing system 106 uses a large language model to generate natural language text output that indicates one or more editing actions to be used in modifying a digital image. In some implementations, the text-to-image editing system 106 uses a large language model to generate executable action code that is compatible with an editing application. Indeed, as will be discussed further below, in some embodiments, the text-to-image editing system 106 uses in-context examples to enable a large language model to generate outputs using a particular format. In some cases, a large language model implements a deep transformer neural network architecture. Some examples of large language models include, but are not limited to, chat generative pre-trained transformer (Chat GPT), Gemini, and Large Language Model Meta AI (LLaMA).

In one or more embodiments, a segmentation model includes a computer-implemented neural network that partitions a digital image into one or more image segments (e.g., distinct portions or objects). In particular, in some embodiments, a segmentation model includes a neural network that analyzes a digital image and determines one or more image segments portrayed therein based on the analysis. In some implementations a segmentation model further generates a mask for each of the determined image segments. In some instances, a segmentation model generates a set of vertices that outline a particular object portrayed within a digital image.

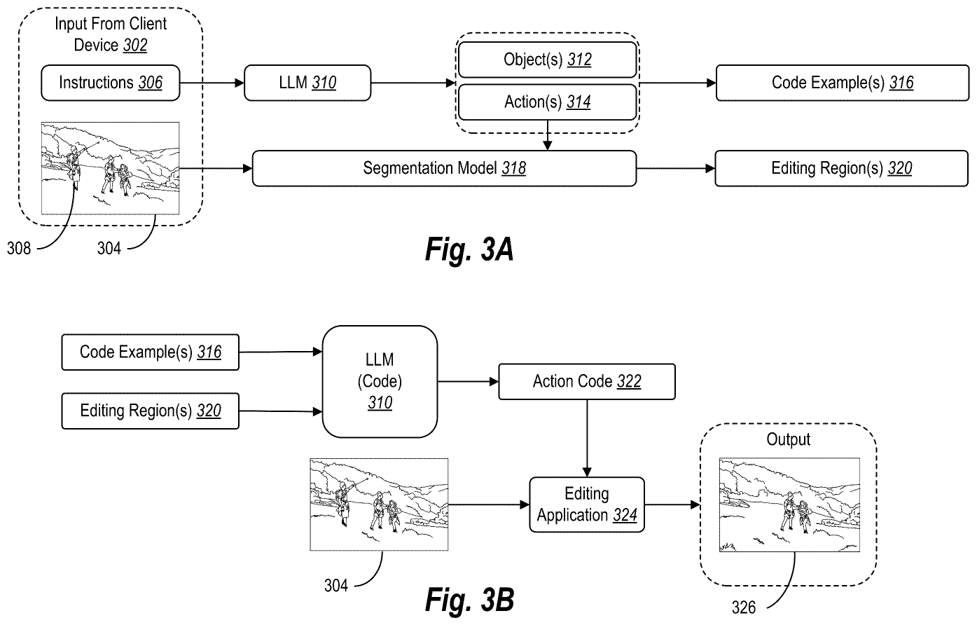

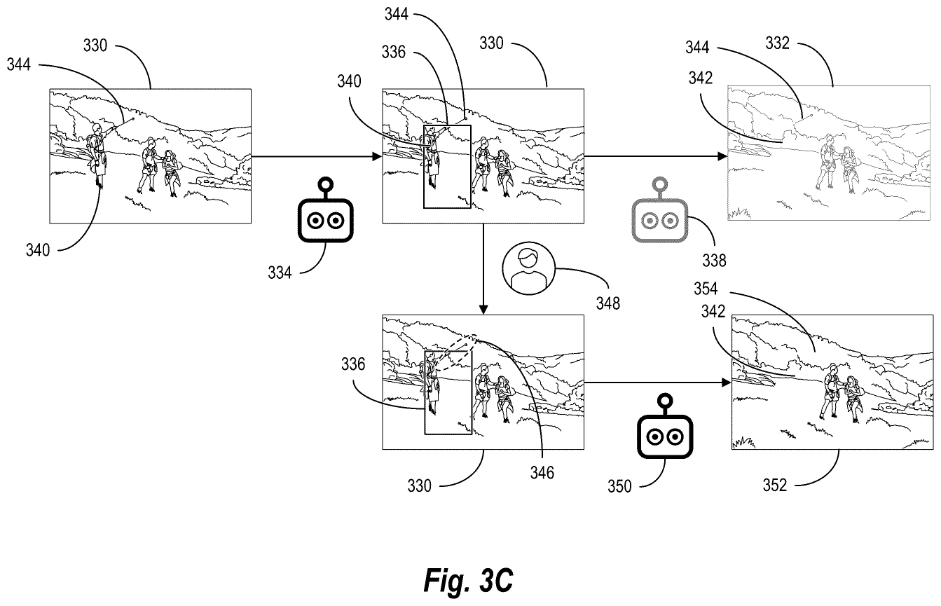

As mentioned, in certain embodiments, the text-to-image editing system 106 modifies a digital image based on natural language text input by generating executable action code from the natural language text input. In particular, in some embodiments, the text-to-image editing system 106 uses a large language model to generate executable action code that implements the instructions provided by the natural language text input. FIGS. 3A-3C illustrate the text-to-image editing system 106 generating and executing executable action code to modify a digital image based on natural language text input in accordance with one or more embodiments.

For instance, as shown in FIG. 3A, the text-to-image editing system 106 receives input 302 from a client device. In particular, the text-to-image editing system 106 receives a digital image 304 and instructions 306 (e.g., in the form of natural language text input) for modifying the digital image 304. For instance, in some cases, the instructions 306 indicate that an object 308 (i.e., the left-most person) is to be removed from the digital image 304.

As further shown, the text-to-image editing system 106 provides the instructions 306 (i.e., the natural language text input) as input to a large language model 310. The text-to-image editing system 106 uses the large language model 310 to determine one or more objects 312 (e.g., the object 308) targeted by the instructions 306 for modification. Further, the text-to-image editing system 106 uses the large language model 310 to determine, from the instructions 306, one or more editing actions 314 to be used in modifying the digital image 304 (e.g., modifying the one or more objects 312). In particular, in one or more embodiments, the text-to-image editing system 106 uses the large language model 310 to generate natural language text output indicating the one or more objects 312 and natural language text output indicating the one or more editing actions 314.

In one or more embodiments, natural language text output includes a text output in the form of natural language. In particular, in some embodiments, natural language text output includes a free-form text that is generated by a large language model and composed of natural language text. In some cases, natural language text output includes a text output generated by a large language model from natural language text input providing instructions for modifying a digital image. For instance, in certain embodiments, natural language text output indicates (e.g., describes) one or more objects that are portrayed within a digital image and targeted for modification or indicates that the digital image as a whole is targeted for modification. In some cases, natural language text output indicates one or more editing actions to be used in modifying the digital image (e.g., modifying the one or more objects or modifying the digital image as a whole) in accordance with natural language text input. As will be discussed below, in some implementations, the text-to-image editing system 106 uses in-context examples to facilitate the generation of natural language text output having a particular format.

In one or more embodiments, an editing action includes an action to be performed in modifying a digital image. In particular, in some embodiments, an editing action includes an action to be performed in modifying either the digital image as a whole or one or more objects portrayed in the digital image. In some cases, an editing action describes a type of action or class of actions that are to be used in modifying a digital image. In some instances, an editing action describes an action for modifying a digital image on a conceptual or class level. For instance, examples of editing actions include, but are not limited to, changing (e.g., increasing or decreasing) a level of exposure, changing hue, adjusting color, changing a level of contrast, adding blur, changing a level of brightness, selecting an object, moving an object, removing an object, adding an object, replacing another object with another object, changing a size of an object, adding text, removing text, adding content fill, or adding a particular effect.

Additionally, as shown in FIG. 3A, the text-to-image editing system 106 determines one or more executable code examples 316 based on the output of the large language model 310. For instance, in some cases, the text-to-image editing system 106 identifies the one or more executable code examples 316 as corresponding to the one or more editing actions 314. To illustrate, in certain embodiments, the text-to-image editing system 106 maintains a database of executable code examples. Upon determining the one or more editing actions 314 from the instructions 306 via the large language model 310, the text-to-image editing system 106 accesses the database to retrieve those executable code examples that correspond to the one or more editing actions 314. For example, in some cases, the text-to-image editing system 106 retrieves those executable code examples that include code that is executable to perform the one or more editing actions 314. In some cases, the text-to-image editing system 106 retrieves those executable code examples further based on their compatibility with (e.g., executability via) the editing application to be used in editing the digital image 304 (i.e., the target editing application).

In one or more embodiments, an executable code example includes an example segment of code that is executable by an editing application. In particular, in some embodiments, an executable code example includes an example code segment for modifying a digital image through execution via an editing application. For instance, in some cases, an executable code example includes an example code segment that is compatible with an editing application (e.g., written in the code language of the editing application or another compatible language and/or are formatted/structured in accordance with the rules of that language and/or the editing application) and causes the editing application (if executed) to perform one or more editing actions with respect to a digital image using one or more editing operations of the editing application. In one or more embodiments, an executable code example includes a code template for performing one or more editing actions via the editing application. In certain implementations, an executable code example includes a code segment that was previously used to perform one or more editing actions through execution of the code segment via the editing application. As will be discussed below, in some implementations, the text-to-image editing system 106 uses the one or more executable code examples 316 to leverage an in-context learning capability of the large language model 310. Indeed, in some cases, as will be explained, an executable code example includes an in-context example used by the text-to-image editing system 106 to facilitate the generation of executable action code by the large language model 310.

As mentioned, in some embodiments, an executable code example is compatible with (e.g., executable via) an editing application. In one or more embodiments, an editing application includes a software application for editing digital images or other digital designs. In particular, in some embodiments, an editing application includes a software application that provides a collection of various tools or features that are usable for modifying digital images. Indeed, in some cases, an editing application provides tools and features for performing editing actions with respect to digital images by invoking corresponding editing operations of the editing application. In certain implementations, an editing application provides a user interface (e.g., a graphical user interface) through which a user selects, configures, and/or applies one or more of the provided tools or features for modifying digital images. In some instances, upon application of a select tool or feature, the editing application operates in the background using one or more editing operations to modify the digital image.

In one or more embodiments, an editing operation includes an operation performed by an editing application in modifying a digital image. In particular, in some embodiments, an editing operation includes an operation performed by an editing application in performing an editing action with respect to a digital image. Indeed, in some implementations, an editing operation includes a software-based operation that is executable by an editing application (e.g., through the execution of code invoking the editing operation) in performing an editing action with respect to a digital image. In some cases, an editing operation has a one-to-one correspondence with an editing action. In other words, in some instances, an editing application performs one editing operation in performing the corresponding editing action to modify a digital image. In some embodiments, however, an editing application performs multiple editing operations in performing the corresponding editing action to modify a digital image.

As further shown in FIG. 3A, the text-to-image editing system 106 provides the digital image 304 as input to a segmentation model 318. Further, the text-to-image editing system 106 provides the one or more objects 312 determined via the large language model 310 (e.g., the natural language text output indicating the one or more objects 312) as input to the segmentation model 318. As illustrated, the text-to-image editing system 106 uses the segmentation model 318 to determine one or more editing regions 320 within the digital image 304 that correspond to the one or more objects 312.

In one or more embodiments, an editing region includes a portion of a digital image to be edited. In particular, in some embodiments an editing region includes a portion of a digital image to which one or more editing actions are to be applied. For example, in some cases, an editing region includes a portion of a digital image identified for modification based on natural language text input providing instructions for modifying an object that corresponds to (e.g., portrayed by) the portion of the digital image.

Indeed, in one or more embodiments, the text-to-image editing system 106 uses the segmentation model 318 to provide a connection between the textual information provided by the instructions 306 and the visual information provided by the digital image 304. In particular, in some embodiments, while the text-to-image editing system 106 uses the large language model 310 to textually determine the one or more objects 312 indicated by the instructions 306, the text-to-image editing system 106 uses the segmentation model 318 to visually determine the one or more portions (e.g., the one or more editing regions 320) of the digital image 304 that correspond to the one or more objects 312. For example, in some implementations, the text-to-image editing system 106 uses the segmentation model 318 to generate a set of vertices that outline the one or more objects 312 within the digital image, thus designating the one or more editing regions 320.

In one or more embodiments, the text-to-image editing system 106 uses, as the segmentation model 318, the on-device masking system described in U.S. patent application Ser. No. 17/589,114, “DETECTING DIGITAL OBJECTS AND GENERATING OBJECT MASKS ON DEVICE,” filed on Jan. 31, 2022, the entire contents of which are hereby incorporated by reference. Alternatively, the text-to-image editing system 106 uses as the segmentation model 318 one of the machine learning models or neural networks described in U.S. patent application Ser. No. 17/158,527, entitled “Segmenting Objects In Digital Images Utilizing A Multi-Object Segmentation Model Framework,” filed on Jan. 26, 2021; or U.S. patent application Ser. No. 16/388,115, entitled “Robust Training of Large-Scale Object Detectors with Noisy Data,” filed on Apr. 8, 2019; or U.S. patent application Ser. No. 16/518,880, entitled “Utilizing Multiple Object Segmentation Models To Automatically Select User-Requested Objects In Images,” filed on Jul. 22, 2019; or U.S. patent application Ser. No. 16/817,418, entitled “Utilizing A Large-Scale Object Detector To Automatically Select Objects In Digital Images,” filed on Mar. 20, 2020;

FIG. 3B illustrates, the text-to-image editing system 106 providing the one or more executable code examples 316 and the one or more editing regions 320 as input to the large language model 310. The text-to-image editing system 106 uses the large language model 310 to generate executable action code 322 from the one or more executable code examples 316 and the one or more editing regions 320. While FIGS. 3A-3B illustrate the text-to-image editing system 106 using the same large language model to determine the one or more objects 312, determine the one or more editing actions 314, and generate the executable action code 322, the text-to-image editing system 106 uses different large language models in different implementations.

In one or more embodiments, executable action code includes code that is executable via an editing application to perform an editing action. In particular, in some embodiments, executable action code includes code that, when executed via an editing application, invokes one or more editing operations of the editing application to perform one or more corresponding editing actions with respect to a digital image. For instance, in some cases, executable action code includes one or more code segments that are compatible with an editing application in that the one or more code segments are written in the code language of the editing application or another compatible language and/or are formatted/structured in accordance with the rules of that language and/or the editing application. In some embodiments, as illustrated in FIG. 3B, executable action code includes one or more code segments generated by a large language model based on natural language text input providing instructions for modifying a digital image (e.g., based on one or more editing regions corresponding to one or more objects indicated by the natural language text input and based on one or more executable code examples corresponding to one or more editing actions indicated by the natural language text input).

As mentioned, in one or more embodiments, the text-to-image editing system 106 uses the one or more executable code examples 316 to leverage an in-context learning capability of the large language model 310 when generating the executable action code 322. For instance, in some embodiments, the text-to-image editing system 106 uses the one or more executable code examples 316 to generate the executable action code 322 to be compatible with a target editing application. Indeed, as previously mentioned, in some cases, the one or more executable code examples 316 are compatible with an editing application in that they are written in the code language of the editing application or another compatible language and/or are formatted/structured in accordance with the rules of that language and/or the editing application. Accordingly, in some cases, the text-to-image editing system 106 uses the one or more executable code examples 316 to facilitate the generation of the executable action code 322 in the code language of the same editing application or another compatible language with a format/structure in accordance with the rules of that language and/or the editing application.

Additionally, in some cases, the text-to-image editing system 106 uses the one or more executable code examples 316 to generate the executable action code 322 to perform (when executed) the one or more editing actions 314 indicated by the instructions 306. Indeed, as previously discussed, in certain embodiments, the text-to-image editing system 106 determines to use the one or more executable code examples 316 based on the one or more executable code examples 316 corresponding to (e.g., being executable to perform) the one or more editing actions 314 indicated by the instructions 306. In particular, in some embodiments, the text-to-image editing system 106 selects the one or more executable code examples 316 based on the one or more executable code examples 316 having code for performing the one or more editing actions 314 (e.g., by invoking one or more corresponding editing operations of the target editing application). Accordingly, in some cases, the text-to-image editing system 106 uses the one or more executable code examples 316 to facilitate the generation of the executable action code 322 to include similar code for performing the one or more editing actions 314.

In one or more embodiments, the text-to-image editing system 106 further uses the one or more editing regions 320 to generate the executable action code 322 to perform (when executed) the one or more editing actions 314 with respect to the one or more editing regions 320. In particular, the text-to-image editing system 106 generates the executable action code 322 to include code that directs the one or more editing actions 314 to modifying the one or more editing regions 320. For instance, in some cases, the executable action code 322 includes one or more segments of code invoking one or more editing operations corresponding to the one or more editing actions 314 and one or more additional segments of code representing one or more parameters of the one or more editing operations. In some cases, at least one of the parameters represents the portion of the digital image to be targeted by the one or more editing operations. Thus, in some implementations, the text-to-image editing system 106 generates the executable action code 322 by generating a code segment that includes one or more parameters instructing the one or more editing operations to target the one or more editing regions 320.

In some cases, in generating the executable action code 322, the text-to-image editing system 106 effectively replaces one or more parameters of the one or more executable code examples 316 with the one or more editing regions 320. Indeed, in some embodiments, the executable action code 322 includes code that is almost identical to the code represented in the one or more executable code examples 316 but differing in the targeted digital image portions. Indeed, in some instances, the text-to-image editing system 106 uses the large language model 310 to generate the executable action code 322 to mimic the code of the one or more executable code examples 316 but insert the one or more editing regions 320 where appropriate.

As shown in FIG. 3B, the text-to-image editing system 106 provides the executable action code 322 to the editing application 324 (i.e., the target editing application). The text-to-image editing system 106 executes the executable action code 322 via the editing application 324 to modify the digital image 304. In particular, the text-to-image editing system 106 executes the executable action code 322 to use one or more editing operations of the editing application 324 to perform the one or more editing actions 314 in modifying the one or more editing regions 320 of the digital image 304. Thus, the text-to-image editing system 106 executes the executable action code 322 to generate a modified digital image 326 from the digital image 304.

By generating executable action code that is executed via an editing application, the text-to-image editing system 106 flexibly leverages the tools and features available from that editing application to offer a more robust set of edits when compared to many conventional systems. Indeed, by invoking the editing operations that are available under an editing operation, one or more embodiments of the text-to-image editing system 106 enables the implementation of those image edits that are available through the editing application. Further, by implementing a process in which executable action code is generated from natural language text input and executed via an editing application to modify a digital image, the text-to-image editing system 106 reduces the number of user interactions required for image editing when compared to many conventional systems. In particular, the text-to-image editing system 106 performs behind the scenes operations to modify a digital image, reducing user interactions to those for entering the natural language text input providing the editing instructions in many instances.

As previously mentioned, in some cases, the text-to-image editing system 106 enables user input to intercede and adjust the action sequence performed in modifying a digital image. Indeed, in some implementations, in modifying a digital image, the text-to-image editing system 106 implements an action sequence, such as an action sequence that includes one or more actions for selecting the editing region(s) to be modified and one or more additional actions for modifying the editing region(s). In certain cases, the text-to-image editing system 106 modifies at least one of the actions in the actions sequence based on received user input. FIG. 3C illustrates the text-to-image editing system 106 modifying an action in an action sequence performed in modifying a digital image in accordance with one or more embodiments.

For instance, as shown in FIG. 3C, the text-to-image editing system 106 performs an action sequence in modifying a digital image 330 to generate a modified digital image 332. In particular, as shown, the text-to-image editing system 106 performs a first action 334 for determining an editing region 336 (shown by the bounding box) of the digital image 330 to modify and a second action 338 for modifying the editing region 336 to generate the modified digital image 332. In particular, as indicated by FIG. 3C, the editing region 336 determined via the first action 334 corresponds to an object 340 (i.e., the left-most person) portrayed in the digital image 330. Further, the text-to-image editing system 106 performs the second action 338 for modifying the editing region 336 by replacing the object 340 (e.g., replacing the pixels of the editing region 336) with content fill 342.

In one or more embodiments, the text-to-image editing system 106 performs the first action 334 as described above with reference to FIG. 3A. In particular, the text-to-image editing system 106 performs the first action 334 by determining an object (i.e., the object 340) targeted for modification by natural language text input using a large language model and determining an editing region (i.e., the editing region 336) within the digital image 330 that corresponds to the object using a segmentation model. Further, in one or more embodiments, the text-to-image editing system 106 performs the second action 338 as described above with reference to FIGS. 3A-3B. In particular, the text-to-image editing system 106 performs the second action 338 by determining one or more editing actions indicated by the natural language text input using a large language model, retrieving one or more executable code examples that correspond to the one or more editing actions, using the large language model to generate executable action code from the determined editing action(s) and the editing region 336, and executing the executable action code via a compatible editing application.

In some cases, the second action 338 includes multiple actions (e.g., multiple editing actions). For instance, in some cases, the second action 338 includes one or more actions for removing the object 340 from the digital image 330 and one or more additional actions for generating and/or positioning the content fill 342 to fill the hole left by removal of the object 340. In some instances, however, the second action 338 includes fewer actions, such as one or more actions for generating and/or positioning the content fill 342 over the top of the object 340 within the digital image 330.

In one or more embodiments, a content fill includes a set of pixels generated to replace another set of pixels of a digital image. Indeed, in some embodiments, a content fill includes a set of replacement pixels for replacing another set of pixels. For instance, in some embodiments, a content fill includes a set of pixels generated to fill a hole (e.g., a content void) that remains after (or if) a set of pixels (e.g., a set of pixels portraying an object) has been removed from or moved within a digital image. In some cases, a content fill corresponds to a background of a digital image. To illustrate, in some implementations, a content fill includes a set of pixels generated to blend in with a portion of a background proximate to an object that could be moved/removed. In some cases, a content fill includes an inpainting segment, such as an inpainting segment generated from other pixels (e.g., other background pixels) within the digital image. In some cases, a content fill includes other content (e.g., arbitrarily selected content or content selected by a user) to fill in a hole or replace another set of pixels.

As shown in FIG. 3C, however, the digital image 330 portrays the object 340 identified for removal/replacement holding an additional object 344 (e.g., a selfie stick for taking pictures). As further shown, the editing region 336 includes the object 340 but excludes the additional object 344. Thus, in some cases, the text-to-image editing system 106 replaces the object 340 with the content fill 342 in generating the modified digital image 332 but fails to replace the additional object 344 with corresponding content fill. As such, the modified digital image 332 provides an unrealistic and undesirable editing result in which the additional object 344 appears to be floating.

In certain implementations, to rectify or prevent such an editing result, the text-to-image editing system 106 enables user input to modify one or more of the actions performed by the text-to-image editing system 106 to modify the digital image 330. For example, as shown in FIG. 3C, the text-to-image editing system 106 detects user input 348 for indicating an additional editing region 346 of the digital image 330 for modification (or for otherwise modifying the editing region 336 previously determined). Based on the user input 348, the text-to-image editing system 106 performs a modified action 350 for modifying the editing region 336 and the additional editing region 346 (or the editing region 336 as modified by the user input 348) to generate the modified digital image 352. In particular, the text-to-image editing system 106 performs the modified action 350 by replacing the object 340 with the content fill 342 and by replacing the additional object 344 with additional content fill 354.

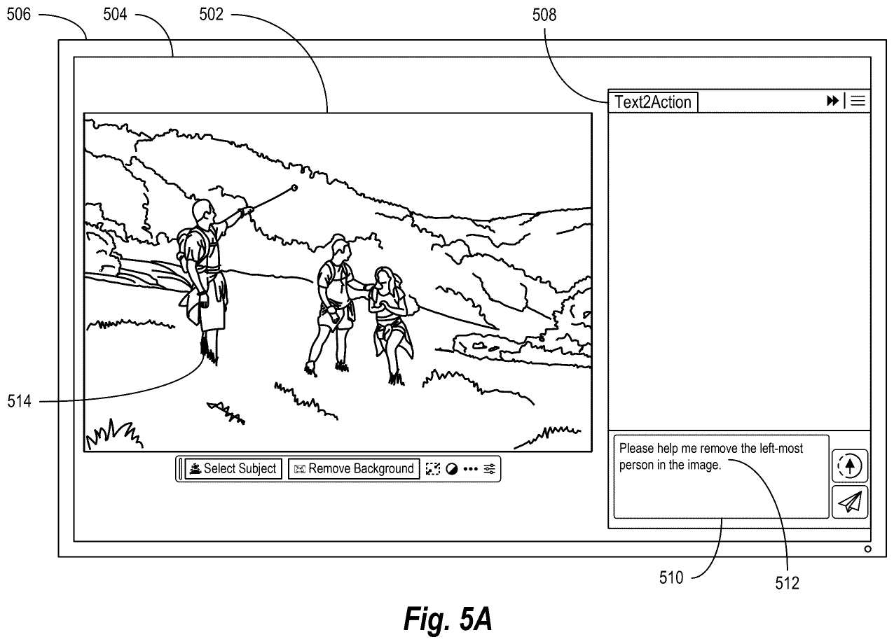

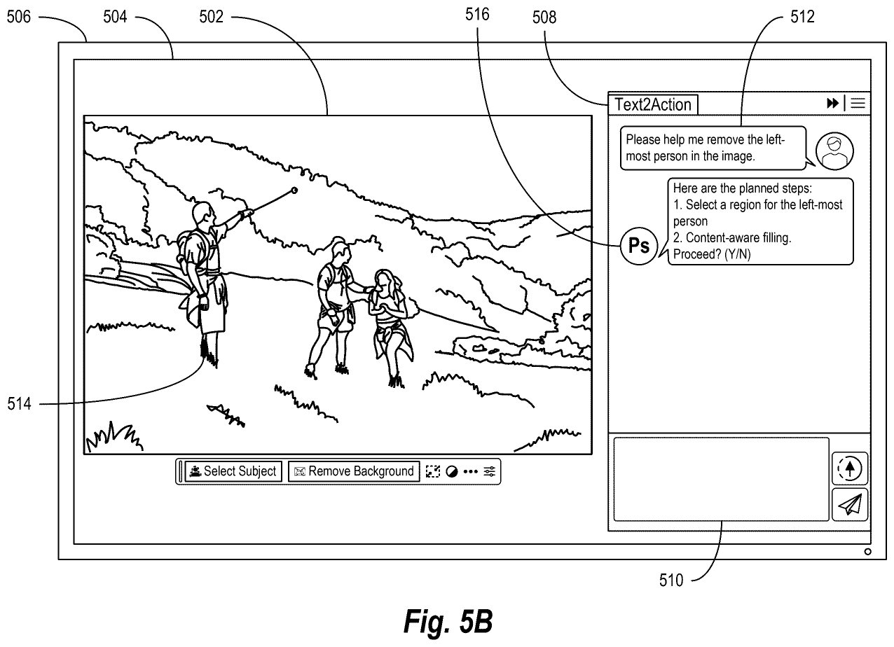

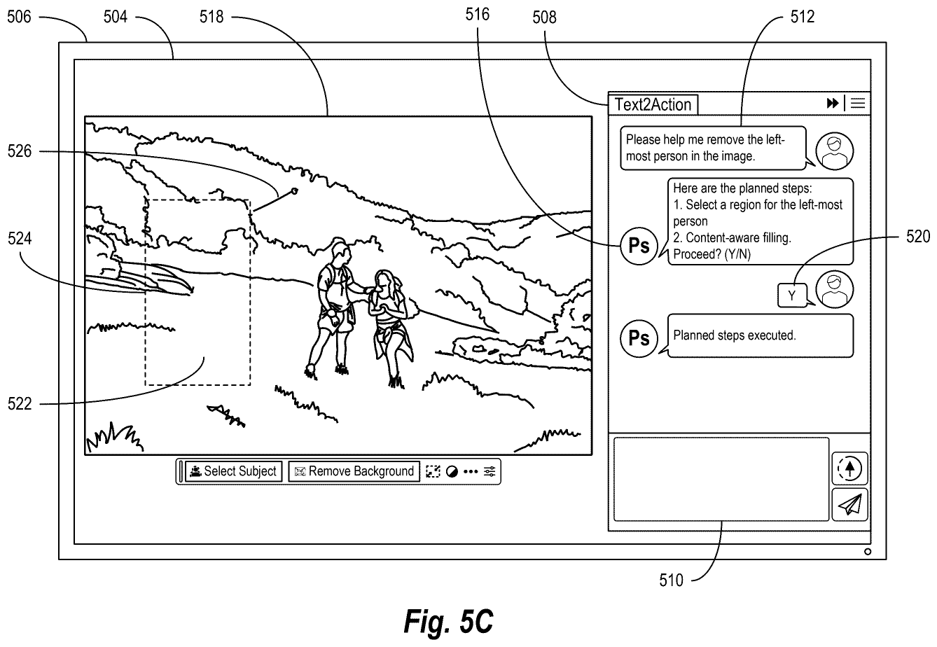

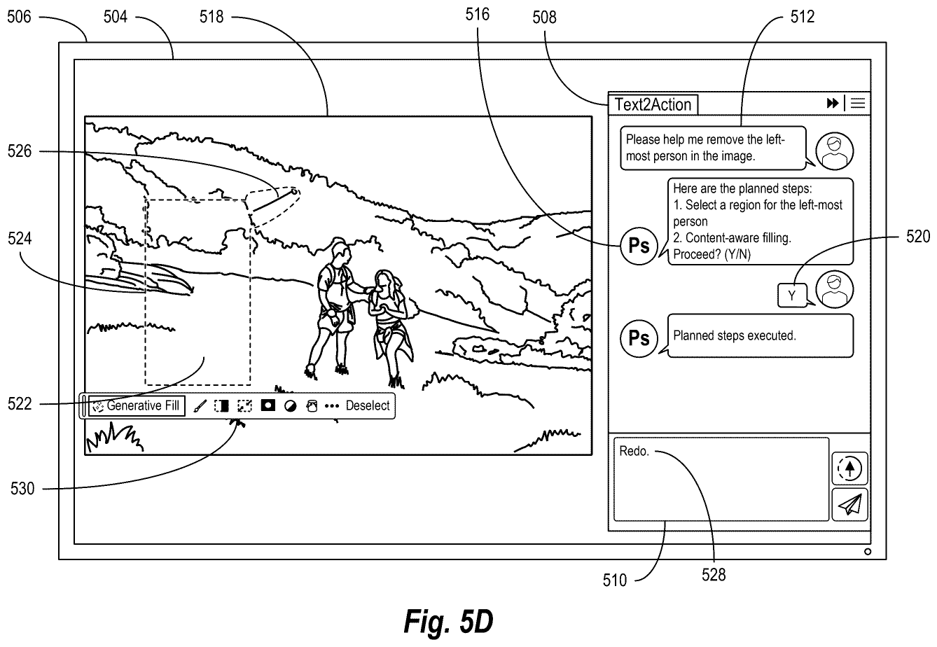

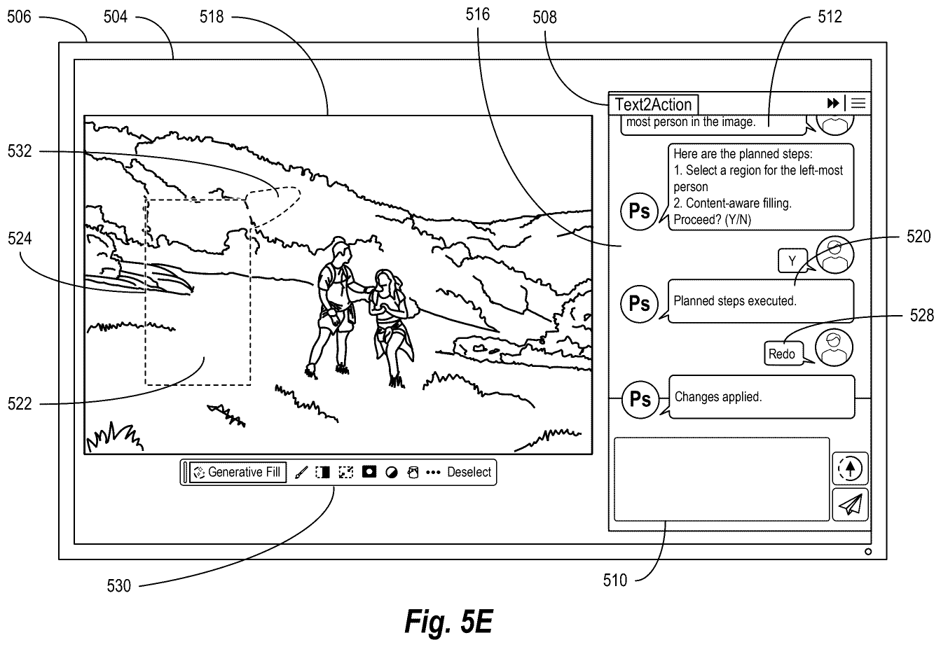

As will be discussed below with reference to FIGS. 5A-5E, in some implementations, the text-to-image editing system 106 generates the modified digital image 332, receives the user input 348, and modifies the modified digital image 332 based on the user input 348 to generate the modified digital image 352. For instance, in some cases, the text-to-image editing system 106 provides the modified digital image 332 for display on a client device to enable user determination of whether further action is required. In some instances, however, the text-to-image editing system 106 provides the editing region 336 for display before modifying the editing region 336 to enable user determination of whether the editing region 336 needs modification.

In some embodiments, the text-to-image editing system 106 modifies the executable action code generated for modifying the digital image 330 (or generates new executable action code) based on the user input 348. Indeed, as previously discussed, in some cases, the text-to-image editing system 106 generates, from instructions provided in the form of natural language text input, executable action code instructing the editing application to modify the editing region 336 via one or more editing operations of the editing application. As such, in some cases, upon detecting the user input 348 for indicating the additional editing region 346 (or for modifying the editing region 336), the text-to-image editing system 106 modifies the executable action code to incorporate the additional editing region 346 (or the editing region 336 as modified) and the one or more editing operations.

In particular, as mentioned, in some instances, the executable action code generated from the natural language text input includes one or more parameters instructing the editing application to modify the editing region. Accordingly, in one or more embodiments, upon detecting the user input 348, the text-to-image editing system 106 modifies the one or more parameters of the executable action code (or generates new executable action code with updated parameters) to incorporate the additional editing region 346 (or the editing region 336 as modified) and the one or more editing operations.

By adjusting the action sequence implementing in modifying a digital image based on received user input, one or more embodiments of the text-to-image editing system 106 operates with improved flexibility when compared to conventional systems. Indeed, as previously mentioned, many conventional systems rely on diffusion models that implement an end-to-end editing process in which a modified image is generated from initial input without allowing for intermediate input. By allowing for intermediate input, one or more embodiments of the text-to-image editing system 106 flexibly modifies the editing results using user-based adjustments to the editing process.

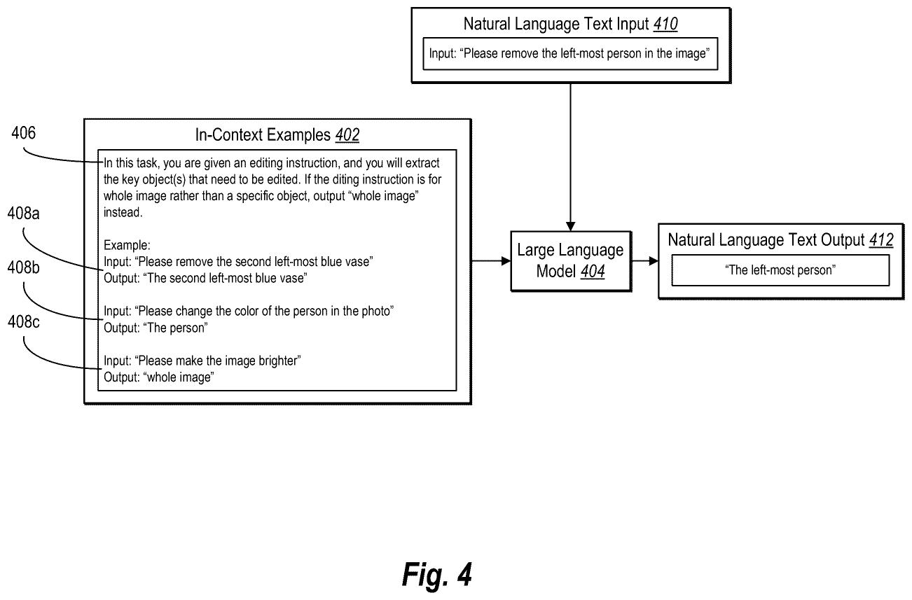

As mentioned, in some implementations, the text-to-image editing system 106 uses in-context examples to facilitate the generation of particular output from a large language model. For instance, in some cases, the text-to-image editing system 106 uses in-context examples to facilitate the generation of output that indicates objects to be modified, editing actions to be used in performing the modification(s), and/or executable action code to be executed via an editing application to perform the modification(s). FIG. 4 illustrates the text-to-image editing system 106 using in-context examples to facilitate the generation of output from a large language model in accordance with one or more embodiments.

In one or more embodiments, an in-context example includes an example provided to a large language model to provide context to the large language model when generating an output from an input. In particular, in some embodiments, an in-context example includes an example provided as input to a large language model to facilitate the generation of output having a particular format and/or language by the large language model. In other words, in some cases, an in-context example restricts the output of a large language model to output having a particular format and/or language. Indeed, in some cases, an in-context example provides an example of the formatting or language to be used by the large language model when generating output. In some cases, an in-context example is provided to the large language model along with additional input such that the large language model generates an output from the additional input but having a format or language indicated by the in-context example. In some cases, an in-context example includes a format for indicating objects targeted by natural language text inputs, includes a format for indicating editing actions from natural language text inputs, or includes an executable code example.

Indeed, FIG. 4 illustrates the text-to-image editing system 106 providing in-context examples 402 to a large language model 404. As shown, the text-to-image editing system 106 provides the in-context examples 402 with a prompt 406. In one or more embodiments, the text-to-image editing system 106 uses the prompt 406 to provide instructions to the large language model 404 regarding the in-context examples 402. For instance, in some cases, the text-to-image editing system 106 uses the prompt 406 to describe how the in-context examples 402 are to be used by the large language model 404. For example, as shown in FIG. 4, the prompt 406 describes how the large language model 404 is to generate an output from a corresponding input. Though FIG. 4 illustrates including the prompt 406 with the in-context examples 402, some implementations of the text-to-image editing system 106 provide one or more in-context examples without a corresponding prompt.

As further illustrated, the text-to-image editing system 106 includes example input-output pairs 408a-408c in the in-context examples 402. In other words, FIG. 4 illustrates each in-context example of the in-context examples 402 having an input-output pair. In one or more embodiments the text-to-image editing system 106 uses each input-output pair to indicate, to the large language model 404, an example of an output that is to be generated from a corresponding input. In particular, the text-to-image editing system 106 uses each input-output pair to instruct the large language model 404 regarding the formatting or language of the output that is to be used based on the corresponding input.

For instance, FIG. 4 illustrates a particular scenario in which the text-to-image editing system 106 uses the example input-output pairs 408a-408c to indicate how the large language model 404 is to generate natural language text output indicating one or more objects targeted for modification by natural language text input. Indeed, in some cases, the large language model 404 is trained and/or configured to generate natural language text output in a natural language manner that is akin to human configuration. As such, in some cases, the large language model 404 is trained and/or configured to generate natural language text output that includes language identifying the desired output (e.g., the object(s) targeted for modification) but also includes additional language that does not directly identify the desired output (e.g., introductory or contextual language). In some cases, this additional language is unhelpful or detrimental to downstream uses, such as using a segmentation model to identify one or more editing regions that correspond to the identified object(s) targeted for modification based on the output of the large language model 404. Thus, in some cases, the text-to-image editing system 106 uses in-context examples to facilitate the generation of more concise natural language text output. Indeed, as shown in FIG. 4, the example outputs of the example input-output pairs 408a-408c each include language identifying the object targeted for modification by the corresponding example input but excludes additional language.

Notably, as FIG. 4 illustrates, the prompt 406 instructs the large language model 404 when to generate natural language text output indicating that the whole image (rather than any particular segment of the image) is to be generated. Further, the example input-output pair 408c provides an example in which the example output indicates that the whole image is targeted for modification based on the included example input.

As further illustrated in FIG. 4, the text-to-image editing system 106 provides natural language text input 410 to the large language model 404 along with the in-context examples 402. The natural language text input 410 provides instructions for editing a digital image (not shown). In particular, the natural language text input 410 indicates an object of the digital image that is targeted for modification (e.g., the left-most person in the image).

As shown, the text-to-image editing system 106 uses the large language model 404 to generate natural language text output 412 from the natural language text input 410. In particular, as shown, the text-to-image editing system 106 uses the large language model 404 to generate the natural language text output 412 to indicate the object targeted for modification by the natural language text input 410 (e.g., the left-most person) in the format of the in-context examples 402. Indeed, the natural language text output 412 includes language identifying the object targeted for modification but excludes additional language in accordance with the in-context examples 402.

Thus, in one or more embodiments, the text-to-image editing system 106 uses in-context examples to facilitate the generation of output by a large language model that is in a desired format. Accordingly, the text-to-image editing system 106 provides flexibility in that the outputs of the large language model are formatted in a manner that enables later use, such as use by a segmentation model to identify editing regions of a digital image that correspond to objects targeted for modification by natural language text input. Though FIG. 4 specifically illustrates the text-to-image editing system 106 using the in-context examples 402 to format outputs that identify objects targeted for modification, one or more embodiments of the text-to-image editing system 106 similar use in-context examples to format outputs that identify editing actions to be used in modifying targeted objects. Indeed, in some cases, the text-to-image editing system 106 provides, to a large language model, one or more in-context examples having a format for indicating editing actions from natural language text inputs. The text-to-image editing system 106 uses the large language model to generate, from a natural language text input, a natural language text output that indicates the one or more editing actions in the format of the one or more in-context examples.

Further, in some implementations, the text-to-image editing system 106 uses one or more in-context examples—in the form of executable code examples—to format the output of a large language model in a format and/or language (e.g., coding language) that is compatible with a target editing application. Indeed, as discussed above with reference to FIG. 3B, in certain cases, the text-to-image editing system 106 provides one or more executable code examples to a large language model along with one or more editing regions of a digital image and one or more editing actions identified from natural language text input. The text-to-image editing system 106 uses the large language model to generate executable action code for applying the editing action(s) to the editing region(s) such that the executable action code is compatible with a target editing application. In particular, in some cases, the text-to-image editing system 106 provides executable code examples that are compatible with the target editing application to facilitate the generation of executable action code that is also compatible with the target editing application.

Though FIG. 4 illustrates each in-context example having an example input-output pair, one or more embodiments of the text-to-image editing system 106 provides in-context examples having only example outputs. For instance, in some cases, the text-to-image editing system 106 uses executable code examples that indicate example executable code outputs without corresponding example inputs. In some cases, however, the text-to-image editing system 106 does provide corresponding example inputs (e.g., corresponding example editing region(s) and/or corresponding example editing action(s)).

As previously mentioned, in one or more embodiments, the text-to-image editing system 106 operates on or otherwise interacts with a computing device, such as a client device. For instance, in some cases, the text-to-image editing system 106 provides a graphical user interface for display on a client device and edits digital images based on user input received via the graphical user interface. FIGS. 5A-5E illustrate the text-to-image editing system 106 modifying a digital image based on user input received via a graphical user interface of a client device in accordance with one or more embodiments.

FIG. 5A illustrates the text-to-image editing system 106 providing a digital image 502 for display within a graphical user interface 504 of a client device 506. As shown in FIG. 5A, the text-to-image editing system 106 provides a panel 508 for display within the graphical user interface 504. In one or more embodiments, the text-to-image editing system 106 uses the panel 508 to provide details regarding the modification of the digital image 502. As further shown, the text-to-image editing system 106 provides a text input box 510 for display within the graphical user interface 504. In some embodiments, the text-to-image editing system 106 receives text input via the text input box 510. For instance, as shown in FIG. 5A, the text-to-image editing system 106 receives, through the text input box 510, natural language text input 512 providing instructions for modifying the digital image 502. In particular, the natural language text input 512 provides instructions for removing an object 514 (i.e., the left-most person) from the digital image 502.

As shown in FIG. 5B, the text-to-image editing system 106 generates and provides an action sequence 516 for display within the panel 508. In particular, the text-to-image editing system 106 presents, for display, the planned steps for implementation in accordance with the instructions of the natural language text input 512. In one or more embodiments, the text-to-image editing system 106 uses a large language model for determining at least part of the action sequence 516 from the natural language text input 512. For example, in some instances, the text-to-image editing system 106 uses the large language model to determine the object 514 targeted by the natural language text input 512 and one or more editing actions for modifying the object 514 in accordance with the natural language text input 512.

FIG. 5B shows the text-to-image editing system 106 providing the action sequence 516 as a sequence of two separate actions: an action for determining an editing region associated with the object 514 targeted by the natural language text input 512 and another action for performing an editing action in accordance with the natural language text input 512. As further shown, the text-to-image editing system 106 requests user confirmation of the action sequence 516. Thus, in some cases, the text-to-image editing system 106 modifies the digital image 502 upon receiving the user confirmation. In certain embodiments, however, the text-to-image editing system 106 proceeds with the action sequence 516 without waiting for confirmation.

As shown in FIG. 5C, after receiving user input providing the user confirmation 520, the text-to-image editing system 106 modifies the digital image 502 and provides the modified digital image 518 for display within the graphical user interface 504. In particular, the text-to-image editing system 106 executes the action sequence 516 to remove the object 514 in accordance with the instructions of the natural language text input 512. Further, the text-to-image editing system 106 replaces the object 514 with content fill 522.

To illustrate, in some cases, the text-to-image editing system 106 uses a segmentation model to identify the editing region 524 associated with the object 514. Further, the text-to-image editing system 106 retrieves one or more executable code examples that correspond to the editing action(s) of the action sequence 516. The text-to-image editing system 106 uses a large language model to generate executable action code from the editing region 524 and the executable code example(s). Using the targeted editing application (e.g., the editing application associated with the graphical user interface 504), the text-to-image editing system 106 executes the executable action code to generate the modified digital image 518.

As shown in FIG. 5C, however, the modified digital image 518 still portrays an additional object 526 that was held by the object 514. In other words, FIG. 5C illustrates a scenario in which implementing the action sequence 516 removed the object 514 as instructed by the natural language text input 512 but failed to remove the additional object 526. Thus, the modified digital image 518 provides an undesirable editing result as the additional object 526 appears to be floating.

As FIG. 5D illustrates, the text-to-image editing system 106 receives, via the graphical user interface 504, additional user input for modifying the editing region 524. In particular, the text-to-image editing system 106 receives additional user input for modifying the editing region 524 to incorporate the additional object 526. To illustrate, in some cases, the text-to-image editing system 106 detects a user selection of one of the tools provided in the tool menu 530 displayed within the graphical user interface 504. The text-to-image editing system 106 further detects user input applying the selected tool to modify the editing region 524. As shown, the text-to-image editing system 106 further receives user input 528 providing instructions for re-executing the action sequence 516.

Indeed, as previously mentioned, the action sequence 516 generated by the text-to-image editing system 106 included a first action for determining an editing region and a second action for implementing an editing action. As indicated by FIG. 5D, the additional user input modifies the first action by modifying the editing region 524. Thus, in some cases, the user input 528 providing the instructions for re-executing the action sequence 516 causes the text-to-image editing system 106 to re-execute the editing action of the action sequence 516 with respect to the editing region 524 as modified.

As illustrated in FIG. 5E, the text-to-image editing system 106 modifies the modified digital image 518 by removing the additional object 526. Further, the text-to-image editing system 106 replaces the additional object 526 with additional content fill 532. Thus, the text-to-image editing system 106 enables user input to adjust the actions implemented in modifying a digital image, offering both efficiency in that operations are performed behind-the-scenes to modify the digital image and flexible control of the user over the editing results.

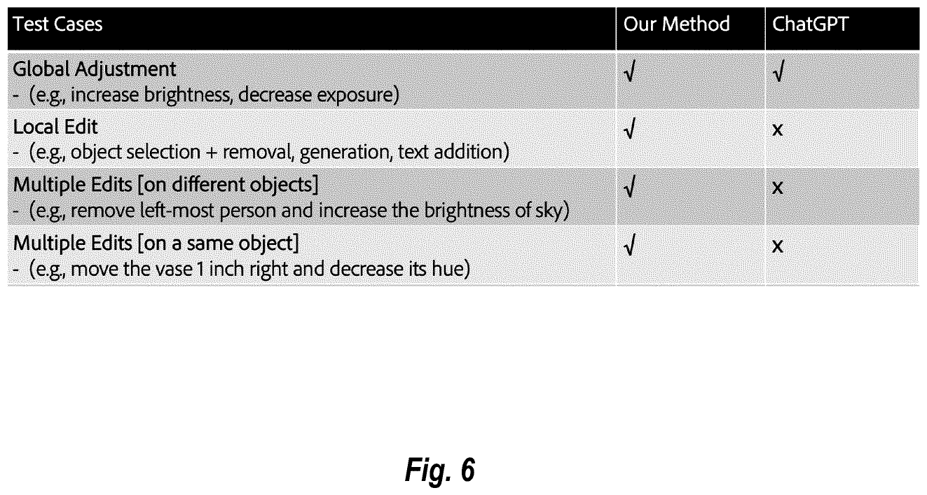

FIG. 6 illustrates a table providing editing features of the text-to-image editing system 106 in accordance with one or more embodiments. In particular, the table of FIG. 6 compares editing features of some embodiments of the text-to-image editing system 106 with features offered by an existing state-of-the-art text-to-image editing system. As shown in FIG. 6, the text-to-image editing system 106 offers improved flexibility in terms of the types of edits that are able to be performed when compared to the existing system. In particular, the text-to-image editing system 106 offers more flexibility by implementing local edits, multiple edits on the same object, and/or multiple edits on different objects. Thus, one or more embodiments of the text-to-image editing system 106 are configured to address a wider variety of natural language text inputs in editing digital images.

Turning now to FIG. 7, additional detail will now be provided regarding various components and capabilities of the text-to-image editing system 106. In particular, FIG. 7 illustrates the text-to-image editing system 106 implemented by the computing device 700 (e.g., the server(s) 102 and/or one of the client devices 110a-110n discussed above with reference to FIG. 1). Additionally, the text-to-image editing system 106 is part of the image editing system 104. As shown, in one or more embodiments, the text-to-image editing system 106 includes, but is not limited to, an in-context example retrieval manager 702, an object extraction engine 704, an editing action extraction engine 706, an editing region extraction engine 708, an action code generator 710, an action code execution engine 712, a user interface manager 714, and data storage 716 (which includes a large language model 718, a segmentation model 720, and in-context examples 722).

As just mentioned, and as illustrated in FIG. 7, the text-to-image editing system 106 includes the in-context example retrieval manager 702. In one or more embodiments, the in-context example retrieval manager 702 retrieves in-context examples to provide to a large language model to facilitate generation of output having a specific format and/or language. For instance, in some cases, the in-context example retrieval manager 702 retrieves in-context examples having a format for indicating objects targeted by natural language text inputs and/or one or more in-context examples having a format for indicating editing actions from natural language text inputs. In some instances, the in-context example retrieval manager 702 retrieves executable code examples to facilitate the generation of executable action code.

Additionally, as shown in FIG. 7, the text-to-image editing system 106 includes the object extraction engine 704. In one or more embodiments, the object extraction engine 704 determines objects targeted for modification by natural language text inputs. For instance, in some cases, the object extraction engine 704 uses a large language model to generate natural language text output indicating a targeted object from natural language text input. In some cases, the object extraction engine 704 uses one or more in-context examples to generate natural language text output having a corresponding format.

Similarly, as shown in FIG. 7, the text-to-image editing system 106 includes the editing action extraction engine 706. In one or more embodiments, the editing action extraction engine 706 determines editing actions indicated by natural language text inputs. For instance, in some cases, the editing action extraction engine 706 uses a large language model to generate natural language text output indicating one or more editing actions described by natural language text input. In some cases, the editing action extraction engine 706 uses one or more in-context examples to generate natural language text output having a corresponding format.

As shown in FIG. 7, the text-to-image editing system 106 further includes the editing region extraction engine 708. In certain embodiments, the editing region extraction engine 708 determines one or more editing regions that corresponds to an object targeted for modification by natural language text input. For instance, in some embodiments, the editing region extraction engine 708 uses a segmentation model to determine one or more editing regions that correspond to targeted objects identified by a large language model.

Further, as shown in FIG. 7, the text-to-image editing system 106 includes the action code generator 710. In one or more embodiments, the action code generator 710 generates executable action code for implementing one or more editing actions with respect to one or more editing regions in accordance with natural language text input. For example, in some cases, the action code generator 710 uses a large language model to generate the executable action code from the editing action(s) and the editing region(s). In some instances, the action code generator 710 uses one or more executable code examples in generating the executable action code.

As shown in FIG. 7, the text-to-image editing system 106 also includes the action code execution engine 712. In one or more embodiments, the action code execution engine 712 executes executable action code to perform one or more editing actions in modifying a digital image. In particular, in some embodiments, the action code execution engine 712 executes the executable action code via an editing application to perform the editing action(s) via one or more editing operations of the editing application.

Additionally, as shown in FIG. 7, the text-to-image editing system 106 includes the user interface manager 714. In one or more embodiments, the text-to-image editing system 106 detects user input received via a graphical user interface. For instance, in some cases, the user interface manager 714 detects natural language text input entered via the graphical user interface and/or additional user input for adjusting an action sequence generated by the text-to-image editing system 106. In some cases, the user interface manager 714 further provides digital images and modified digital images for display within the graphical user interface.

As shown in FIG. 7, the text-to-image editing system 106 further includes data storage 716. In particular, data storage 716 includes the large language model 718, the segmentation model 720, and the in-context examples 722.

Each of the components 702-722 of the text-to-image editing system 106 optionally include software, hardware, or both. For example, in some cases, the components 702-722 include one or more instructions stored on a computer-readable storage medium and executable by processors of one or more computing devices, such as a client device or server device. When executed by the one or more processors, the computer-executable instructions of the text-to-image editing system 106 cause the computing device(s) to perform the methods described herein. Alternatively, in some embodiments, the components 702-722 include hardware, such as a special-purpose processing device to perform a certain function or group of functions. Alternatively, in certain implementations, the components 702-722 of the text-to-image editing system 106 include a combination of computer-executable instructions and hardware.

Furthermore, in one or more embodiments, the components 702-722 of the text-to-image editing system 106 are, for example, implemented as one or more operating systems, as one or more stand-alone applications, as one or more modules of an application, as one or more plug-ins, as one or more library functions or functions that are called by other applications, and/or as a cloud-computing model. Thus, in some embodiments, the components 702-722 of the text-to-image editing system 106 are implemented as a stand-alone application, such as a desktop or mobile application. Furthermore, in some cases, the components 702-722 of the text-to-image editing system 106 are implemented as one or more web-based applications hosted on a remote server. Alternatively, or additionally, the components 702-722 of the text-to-image editing system 106 are implemented in a suite of mobile device applications or “apps.” For example, in one or more embodiments, the text-to-image editing system 106 comprises or operates in connection with digital software applications such as ADOBE® PHOTOSHOP® or ADOBE® LIGHTROOM®. The foregoing are either registered trademarks or trademarks of Adobe Inc. in the United States and/or other countries.

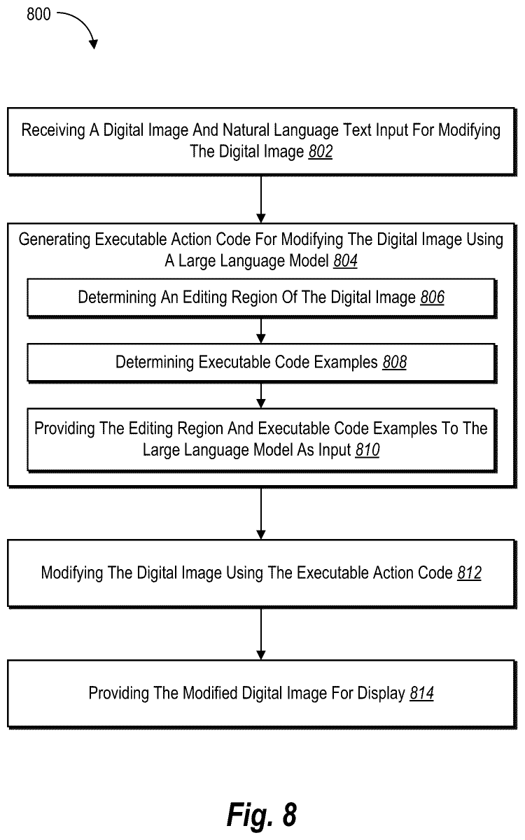

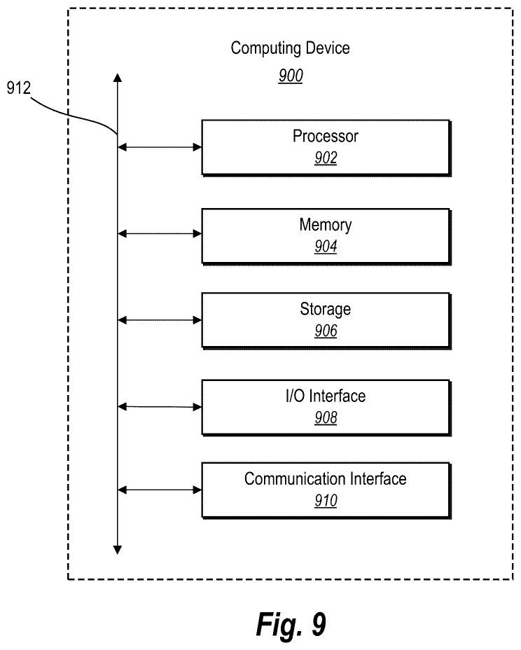

FIGS. 1-7, the corresponding text, and the examples provide a number of different methods, systems, devices, and non-transitory computer-readable media of the text-to-image editing system 106. In addition to the foregoing, one or more embodiments are also described in terms of flowcharts comprising acts for accomplishing the particular result, as shown in FIG. 8. In one or more embodiments, FIG. 8 is performed with more or fewer acts. Further, in some embodiments, the acts are performed in different orders. Additionally, in some cases, the acts described herein are repeated or performed in parallel with one another or in parallel with different instances of the same or similar acts.

FIG. 8 illustrates a flowchart of a series of acts 800 for performing text-to-image editing using executable code generated from natural language text input in accordance with one or more embodiments. FIG. 8 illustrates acts according to one embodiment, but alternative embodiments omit, add to, reorder, and/or modify any of the acts shown in FIG. 8. In some implementations, the acts of FIG. 8 are performed as part of a computer-implemented method. Alternatively, in some embodiments, a non-transitory computer-readable medium stores executable instructions thereon that, when executed by a processing device, cause the processing device to perform operations comprising the acts of FIG. 8. In some embodiments, a system performs the acts of FIG. 8. For example, in some cases, a system includes one or more memory devices. The system further includes one or more processors configured to cause the system to perform the acts of FIG. 8.

The series of acts 800 includes an act 802 for receiving a digital image and natural language text input for modifying the digital image. For example, in one or more embodiments, the act 802 involves receiving, from a client device, a digital image and natural language text input providing instructions for modifying the digital image.

The series of acts 800 also includes an act 804 for generating executable action code for modifying the digital image using a large language model. For instance, in some embodiments, the act 804 involves generating, using a large language model, executable action code for modifying the digital image in accordance with the instructions of the natural language text input, the executable action code being compatible with an editing application. In one or more embodiments, generating the executable action code for modifying the digital image comprises generating the executable action code for modifying an editing region from the digital image using one or more editing operations of the editing application.

Indeed, as shown in FIG. 8, the act 804 includes a sub-act 806 for determining an editing region of the digital image. As further shown, the act 804 includes a sub-act 808 for determining executable code examples and a sub-act 810 for providing the editing region and the executable code examples to the large language model as input.

In one or more embodiments, the text-to-image editing system 106 determines, using the large language model, an object that is targeted by the natural language text input for modification; and determines, using a segmentation model, an editing region of the digital image that corresponds to the object. As such, in some cases, generating the executable action code for modifying the digital image in accordance with the instructions of the natural language text input comprises generating the executable action code for modifying the editing region of the digital image. In some instances, determining, using the segmentation model, the editing region of the digital image that corresponds to the object comprises generating, using the segmentation model, a set of vertices that outline the object within the digital image.

In certain embodiments, the text-to-image editing system 106 provides, to the large language model, one or more in-context examples having a format for indicating objects targeted by natural language text inputs. As such, in some cases, determining, using the large language model, the object that is targeted by the natural language text input for modification comprises generating, using the large language model, a natural language text output that indicates the object in the format of the one or more in-context examples.

In some implementations, the text-to-image editing system 106 determines, from the natural language text input using the large language model, one or more editing actions for modifying the digital image; and determines one or more executable code examples for the editing application that correspond to the one or more editing actions. Thus, in some instances, generating the executable action code for modifying the digital image in accordance with the instructions of the natural language text input comprises generating the executable action code for modifying the digital image using one or more editing operations of the editing application that correspond to the one or more editing actions.

In certain cases, the text-to-image editing system 106 provides, to the large language model, one or more in-context examples having a format for indicating editing actions from natural language text inputs. Accordingly, in some embodiments, determining, from the natural language text input using the large language model, the one or more editing actions for modifying the digital image comprises generating, from the natural language text input using the large language model, a natural language text output that indicates the one or more editing actions in the format of the one or more in-context examples.

Additionally, the series of acts 800 includes an act 812 for modifying the digital image using the executable action code. To illustrate, in some cases, the act 812 involves modifying the digital image by executing the executable action code via the editing application.

In one or more embodiments, the text-to-image editing system 106 further receives, via the client device, user input for modifying the editing region within the digital image; generates, using the large language model, additional executable action code that incorporates the modified editing region and the one or more editing operations; and modifies the modified digital image by executing the additional executable action code via the editing application. To illustrate, in some embodiments, receiving the natural language text input providing the instructions for modifying the digital image comprises receiving the natural language text input providing the instructions to remove a first object portrayed in the digital image, the first object holding a second object; modifying the digital image comprises removing the first object from the digital image while leaving the second object in the digital image based the editing region including the first object and excluding the second object; and receiving the user input for modifying the editing region within the digital image comprises receiving the user input for adding the second object into the editing region.

Further, the series of acts 800 includes an act 814 for providing the modified digital image for display. Indeed, in some cases, the act 814 involves providing the modified digital image for display via a graphical user interface of the client device.

To provide an illustration, in one or more embodiments, the text-to-image editing system 106 receives a digital image and natural language text input providing instructions for modifying the digital image; determines, from the natural language text input using a large language model, an object targeted for modification and one or more editing actions for modifying the object; determines, using a segmentation model, an editing region of the digital image that corresponds to the object; generates, using the large language model, executable action code for modifying the editing region of the digital image using one or more editing operations that correspond to the one or more editing actions, the executable action code being compatible with an editing application; and modifies the digital image by executing the executable action code via the editing application.

In some embodiments, the text-to-image editing system 106 generates the executable action code for modifying the editing region of the digital image using the one or more editing operations by generating a code segment that includes one or more parameters instructing the editing application to modify the editing region via the one or more editing operations. In some instances, the text-to-image editing system 106 further determines an executable code example having an additional code segment that includes one or more additional parameters for instructing the editing application to modify an additional editing region of an additional digital image via the one or more editing operations; and generates the executable action code using the large language model by generating the executable action code from the executable code example using the large language model.

In some cases, the text-to-image editing system 106 further receives, via a client device, user input for modifying the editing region within the digital image; generates, using the large language model, additional executable action code that modifies the one or more parameters of the executable action code to incorporate the modified editing region; and modifies the modified digital image by executing the additional executable action code via the editing application.

In some embodiments, the text-to-image editing system 106 further determines, from the natural language text input using the large language model, an additional object targeted for modification; and determines, using the segmentation model, an additional editing region of the digital image that corresponds to the additional object. Thus, in some cases, the text-to-image editing system 106 further generates, using the large language model, additional executable action code for modifying the additional editing region of the digital image; and modifies the digital image by executing the additional executable action code via the editing application.

In one or more embodiments, the text-to-image editing system 106 further provides, to the large language model, one or more in-context examples that restricts outputs of the large language model to language identifying objects targeted by natural language text inputs; and determines, from the natural language text input using the large language model, the object targeted for modification by generating, using the large language model, a natural language text output that includes language identifying the object and excludes additional language in accordance with the one or more in-context examples.

To provide another illustration, in one or more embodiments, the text-to-image editing system 106 receives a digital image and natural language text input providing instructions for modifying an object portrayed within the digital image; determines one or more executable code examples that correspond to modifying the object in accordance with the natural language text input; generates, using a large language model, executable action code for modifying the object in accordance with the instructions of the natural language text input based on the one or more executable code examples, the executable action code being compatible with an editing application; and modifies the object within the digital image by executing the executable action code via the editing application.

In some cases, receiving the natural language text input providing the instructions for modifying the object portrayed within the digital image comprises receiving the natural language text input providing the instructions for removing the object from the digital image; and modifying the object within the digital image by executing the executable action code via the editing application comprises executing the executable action code to replace the object with a content fill within the digital image. In some instances, the text-to-image editing system 106 further provides, as input to the large language model, the one or more executable code examples and an editing region that corresponds to the object to be modified. As such, in certain embodiments, generating, using the large language model, the executable action code comprises generating, using the large language model, the executable action code based on the one or more executable code examples and the editing region. In one or more embodiments, the text-to-image editing system 106 determines the editing region that corresponds to the object to be modified by using a segmentation model to generate a set of vertices that outline the object within the digital image.

Some embodiments of the present disclosure comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, in some cases, one or more of the processes described herein are implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

In one or more embodiments, computer-readable media include various available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, one or more embodiments of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which is usable to store desired program code means in the form of computer-executable instructions or data structures and which is accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some cases, transmissions media includes a network and/or data links which are usable to carry desired program code means in the form of computer-executable instructions or data structures and which is accessible by a general purpose or special purpose computer. Combinations of the above should also be included within the scope of computer-readable media.

Further, upon reaching various computer system components, program code means in the form of computer-executable instructions or data structures is transferrable automatically from transmission media to non-transitory computer-readable storage media (devices) (or vice versa). For example, in some cases, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some cases, non-transitory computer-readable storage media (devices) are included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. In some instances, the computer executable instructions are, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that one or more embodiments are practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. Some implementations are practiced in distributed system environments where local and remote computer systems, which are linked (either by hardwired data links, wireless data links, or by a combination of hardwired and wireless data links) through a network, both perform tasks. In some implementations, in a distributed system environment, program modules are located in both local and remote memory storage devices.

Some embodiments of the present disclosure are implemented in cloud computing environments. In this description, “cloud computing” is defined as a model for enabling on-demand network access to a shared pool of configurable computing resources. For example, in some cases, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some embodiments, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that is configured to perform one or more of the processes described above in some embodiments. One will appreciate that one or more computing devices, such as the computing device 900, represent the computing devices described above (e.g., the server(s) 102 and/or the client devices 110a-110n) in some implementations. In one or more embodiments, the computing device 900 is a mobile device (e.g., a mobile telephone, a smartphone, a PDA, a tablet, a laptop, a camera, a tracker, a watch, a wearable device). In some embodiments, the computing device 900 is a non-mobile device (e.g., a desktop computer or another type of client device). Further, in certain embodiments, the computing device 900 is a server device that includes cloud-based processing and storage capabilities.

As shown in FIG. 9, the computing device 900 includes one or more processor(s) 902, memory 904, a storage device 906, input/output interfaces 908 (or “I/O interfaces 908”), and a communication interface 910, which are communicatively coupled by way of a communication infrastructure (e.g., bus 912). While the computing device 900 is shown in FIG. 9, the components illustrated in FIG. 9 are not intended to be limiting. Additional or alternative components are used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 retrieve (or fetch) the instructions from an internal register, an internal cache, memory 904, or a storage device 906 and decode and execute them in some implementations.

The computing device 900 includes memory 904, which is coupled to the processor(s) 902. In certain cases, the memory 904 is used for storing data, metadata, and programs for execution by the processor(s). In some instances, the memory 904 includes one or more of volatile and non-volatile memories, such as Random-Access Memory (“RAM”), Read-Only Memory (“ROM”), a solid-state disk (“SSD”), Flash, Phase Change Memory (“PCM”), or other types of data storage. In some embodiments, the memory 904 includes internal or distributed memory.

The computing device 900 includes a storage device 906 including storage for storing data or instructions. As an example, and not by way of limitation, in some cases, the storage device 906 includes a non-transitory storage medium described above. In some embodiments, the storage device 906 includes a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. In one or more embodiments, these I/O interfaces 908 include a mouse, keypad or a keyboard, a touch screen, camera, optical scanner, network interface, modem, other known I/O devices or a combination of such I/O interfaces 908. In some cases, the touch screen is activated with a stylus or a finger.

In one or more embodiments, the I/O interfaces 908 include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. In some cases, the graphical data is representative of one or more graphical user interfaces and/or any other graphical content that serves a particular implementation.

The computing device 900 further includes a communication interface 910. In some cases, the communication interface 910 includes hardware, software, or both. The communication interface 910 provides one or more interfaces for communication (such as, for example, packet-based communication) between the computing device and one or more other computing devices or one or more networks. As an example, and not by way of limitation, in some cases, communication interface 910 includes a network interface controller (NIC) or network adapter for communicating with an Ethernet or other wire-based network or a wireless NIC (WNIC) or wireless adapter for communicating with a wireless network, such as a WI-FI. The computing device 900 further includes a bus 912. In some cases, the bus 912 includes hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

Various implementations of the present invention are embodied in other specific forms without departing from its spirit or essential characteristics. The described embodiments are to be considered in all respects only as illustrative and not restrictive. For example, in some embodiments, the methods described herein are performed with less or more steps/acts or the steps/acts are performed in differing orders. Additionally, in some cases, the steps/acts described herein are repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a client device, a digital image and natural language text input providing instructions for modifying the digital image;
generating, using a large language model, executable action code for modifying the digital image in accordance with the instructions of the natural language text input, the executable action code being compatible with an editing application;
modifying the digital image by executing the executable action code via the editing application; and
providing the modified digital image for display via a graphical user interface of the client device.

2. The computer-implemented method of claim 1, wherein generating the executable action code for modifying the digital image comprises generating the executable action code for modifying an editing region from the digital image using one or more editing operations of the editing application.

3. The computer-implemented method of claim 2, further comprising:
receiving, via the client device, user input for modifying the editing region within the digital image;
generating, using the large language model, additional executable action code that incorporates the modified editing region and the one or more editing operations; and
modifying the modified digital image by executing the additional executable action code via the editing application.

4. The computer-implemented method of claim 3, wherein:
receiving the natural language text input providing the instructions for modifying the digital image comprises receiving the natural language text input providing the instructions to remove a first object portrayed in the digital image, the first object holding a second object;
modifying the digital image comprises removing the first object from the digital image while leaving the second object in the digital image based the editing region including the first object and excluding the second object; and
receiving the user input for modifying the editing region within the digital image comprises receiving the user input for adding the second object into the editing region.

5. The computer-implemented method of claim 1, further comprising:
determining, using the large language model, an object that is targeted by the natural language text input for modification; and
determining, using a segmentation model, an editing region of the digital image that corresponds to the object,
wherein generating the executable action code for modifying the digital image in accordance with the instructions of the natural language text input comprises generating the executable action code for modifying the editing region of the digital image.

6. The computer-implemented method of claim 5,
further comprising providing, to the large language model, one or more in-context examples having a format for indicating objects targeted by natural language text inputs,
wherein determining, using the large language model, the object that is targeted by the natural language text input for modification comprises generating, using the large language model, a natural language text output that indicates the object in the format of the one or more in-context examples.

7. The computer-implemented method of claim 5, wherein determining, using the segmentation model, the editing region of the digital image that corresponds to the object comprises generating, using the segmentation model, a set of vertices that outline the object within the digital image.

8. The computer-implemented method of claim 1, further comprising:
determining, from the natural language text input using the large language model, one or more editing actions for modifying the digital image; and
determining one or more executable code examples for the editing application that correspond to the one or more editing actions,
wherein generating the executable action code for modifying the digital image in accordance with the instructions of the natural language text input comprises generating the executable action code for modifying the digital image using one or more editing operations of the editing application that correspond to the one or more editing actions.

9. The computer-implemented method of claim 8,
further comprising providing, to the large language model, one or more in-context examples having a format for indicating editing actions from natural language text inputs,
wherein determining, from the natural language text input using the large language model, the one or more editing actions for modifying the digital image comprises generating, from the natural language text input using the large language model, a natural language text output that indicates the one or more editing actions in the format of the one or more in-context examples.

10. A system comprising:
one or more memory devices; and
one or more processors configured to cause the system to:
receive a digital image and natural language text input providing instructions for modifying the digital image;
determine, from the natural language text input using a large language model, an object targeted for modification and one or more editing actions for modifying the object;
determine, using a segmentation model, an editing region of the digital image that corresponds to the object;
generate, using the large language model, executable action code for modifying the editing region of the digital image using one or more editing operations that correspond to the one or more editing actions, the executable action code being compatible with an editing application; and
modify the digital image by executing the executable action code via the editing application.

11. The system of claim 10, wherein the one or more processors are configured to cause the system to generate the executable action code for modifying the editing region of the digital image using the one or more editing operations by generating a code segment that includes one or more parameters instructing the editing application to modify the editing region via the one or more editing operations.

12. The system of claim 11, wherein the one or more processors are further configured to cause the system to:
determine an executable code example having an additional code segment that includes one or more additional parameters for instructing the editing application to modify an additional editing region of an additional digital image via the one or more editing operations; and
generate the executable action code using the large language model by generating the executable action code from the executable code example using the large language model.

13. The system of claim 11, wherein the one or more processors are further configured to cause the system to:
receive, via a client device, user input for modifying the editing region within the digital image;
generate, using the large language model, additional executable action code that modifies the one or more parameters of the executable action code to incorporate the modified editing region; and
modify the modified digital image by executing the additional executable action code via the editing application.

14. The system of claim 10, wherein the one or more processors are further configured to cause the system to:
determine, from the natural language text input using the large language model, an additional object targeted for modification; and
determine, using the segmentation model, an additional editing region of the digital image that corresponds to the additional object.

15. The system of claim 14, wherein the one or more processors are further configured to cause the system to:
generate, using the large language model, additional executable action code for modifying the additional editing region of the digital image; and
modify the digital image by executing the additional executable action code via the editing application.

16. The system of claim 10, wherein the one or more processors are further configured to cause the system to:
provide, to the large language model, one or more in-context examples that restricts outputs of the large language model to language identifying objects targeted by natural language text inputs; and
determine, from the natural language text input using the large language model, the object targeted for modification by generating, using the large language model, a natural language text output that includes language identifying the object and excludes additional language in accordance with the one or more in-context examples.

17. A non-transitory computer-readable medium storing executable instructions which, when executed by a processing device, cause the processing device to perform operations comprising:
receiving a digital image and natural language text input providing instructions for modifying an object portrayed within the digital image;
determining one or more executable code examples that correspond to modifying the object in accordance with the natural language text input;
generating, using a large language model, executable action code for modifying the object in accordance with the instructions of the natural language text input based on the one or more executable code examples, the executable action code being compatible with an editing application; and
modifying the object within the digital image by executing the executable action code via the editing application.

18. The non-transitory computer-readable medium of claim 17, wherein:
receiving the natural language text input providing the instructions for modifying the object portrayed within the digital image comprises receiving the natural language text input providing the instructions for removing the object from the digital image; and
modifying the object within the digital image by executing the executable action code via the editing application comprises executing the executable action code to replace the object with a content fill within the digital image.

19. The non-transitory computer-readable medium of claim 17, wherein:
the operations further comprise providing, as input to the large language model, the one or more executable code examples and an editing region that corresponds to the object to be modified; and
generating, using the large language model, the executable action code comprises generating, using the large language model, the executable action code based on the one or more executable code examples and the editing region.

20. The non-transitory computer-readable medium of claim 19, wherein the operations further comprise determining the editing region that corresponds to the object to be modified by using a segmentation model to generate a set of vertices that outline the object within the digital image.
